(19) United States
(12) Patent Application Publication
(10) Pub. No.: US 2025/0184052 A1
(43) Pub. Date: Jun. 5, 2025

(54) SYSTEMS, METHODS, AND DEVICES FOR WIRELESS COEXISTENCE ENHANCEMENT USING FREQUENCY HOPPING

(71) Applicant: Cypress Semiconductor Corporation, San Jose, CA (US)

(72) Inventors: Rakesh Taori, McKinney, TX (US); Kiran Uln, Pleasanton, CA (US)

(73) Assignee: Cypress Semiconductor Corporation, San Jose, CA (US)

(21) Appl. No.: 18/530,196

(22) Filed: Dec. 5, 2023

(51) Int. Cl. H04L 5/00; H04L 1/00; H04L 1/1607

(52) U.S. Cl. CPC H04L 5/0012; H04L 1/0069; H04L 1/1614; H04L 5/0037

(57) ABSTRACT

Systems, methods, and devices provide improved coexistence of collocated transceivers. Methods include identifying, using one or more processing elements, wireless activity associated with a first transceiver, the first transceiver being collocated with a second transceiver, and generating, using the one or more processing elements, a puncture pattern for the first transceiver based, at least in part, on the identified wireless activity, the puncture pattern identifying an unused plurality of sub-channels of the first transceiver. Methods also include generating, using the one or more processing elements, a hopping pattern for the second transceiver based, at least in part, on the puncture pattern, the hopping pattern identifying a sequence of sub-channels used by the second transceiver for wireless activity, and the hopping pattern including at least some of the plurality of sub-channels identified by the puncture pattern.

### TECHNICAL FIELD

This disclosure relates to wireless devices, and more specifically, to enhancement of coexistence between transceivers in such wireless devices.

### BACKGROUND

Wireless devices may include various components to facilitate communication between devices. For example, wireless devices may include transceivers and associated processing components that may implement communications operations in accordance with wireless protocols. Wireless devices may include more than one transceiver. Accordingly, transceivers may be collocated in a wireless device and may share access to one or more components of a wireless communications medium. Conventional techniques for implementing coexistence of such collocated transceivers remain limited because they are not able to efficiently utilize the bandwidth available to the collocated transceivers.

### BRIEF DESCRIPTION OF THE DRAWINGS

FIG. 1 illustrates an example of a system for coexistence enhancement, configured in accordance with some embodiments.

FIG. 2A illustrates an example of a device for coexistence enhancement, configured in accordance with some embodiments.

FIG. 2B illustrates another example of a device for coexistence enhancement, configured in accordance with some embodiments.

FIG. 3 illustrates an example of a method for coexistence enhancement, performed in accordance with some embodiments.

FIG. 4 illustrates another example of a method for coexistence enhancement, performed in accordance with some embodiments.

FIG. 5 illustrates an additional example of a method for coexistence enhancement, performed in accordance with some embodiments.

FIG. 6 illustrates another example of a method for coexistence enhancement, performed in accordance with some embodiments.

FIG. 7 illustrates an example of a diagram of various sub-channels and puncture features, configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may implement one or more coexistence techniques to facilitate the operation of multiple collocated transceivers and their associated processing components. For example, a transceiver compatible with a first wireless protocol, such as a Wi-Fi protocol, may be collocated with a transceiver compatible with a second wireless protocol, such as a Bluetooth protocol. Each transceiver may have a designated bandwidth including a designated frequency range over which the transceiver may operate. It will be appreciated that such designated frequency ranges may overlap in operational frequencies and/or time. Moreover, the bandwidth may be divided into channels and sub-channels. While conventional collocated transceivers may implement some coexistence techniques such as medium reservation, such techniques remain limited because they may result in increased latency and/or inefficient bandwidth usage.

Embodiments disclosed herein provide efficient usage of bandwidth available to collocated transceivers. More specifically, a first transceiver and a collocated second transceiver may be configured to communicate to facilitate enabling the second transceiver to use unused sub-channels of the first transceiver. More specifically, the first transceiver may implement a puncturing scheme, and may enable the second transceiver to use the punctured sub-channels. In this way, bandwidth of the first transceiver may be partitioned and shared with the second transceiver to increase bandwidth available to the second transceiver, and more efficiently use the bandwidth available to the first transceiver.

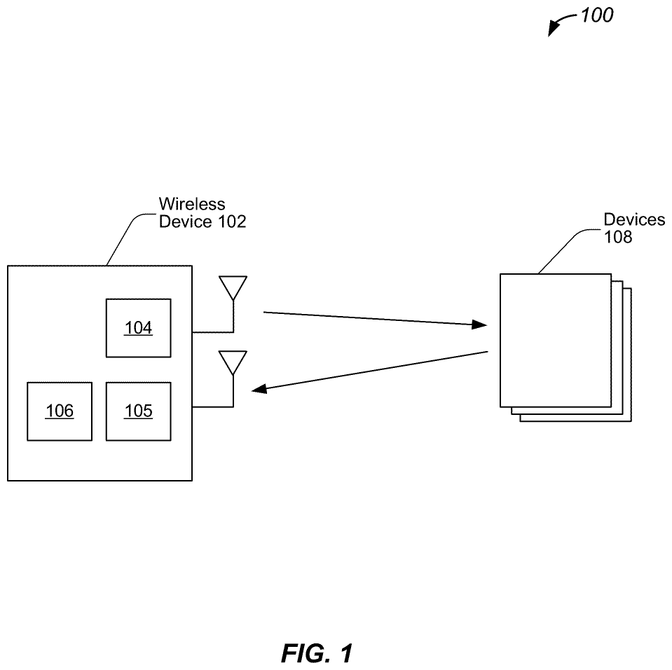

FIG. 1 illustrates an example of a system for coexistence enhancement, configured in accordance with some embodiments. Accordingly, a system, such as system 100, may include wireless devices that are used for wireless communications, and are also configured to be able to perform coexistence enhancement operations as disclosed herein. Accordingly, as will be discussed in greater detail below, wireless devices included in system 100 may be configured to determine puncture patterns and hopping patterns.

In various embodiments, system 100 may include wireless device 102 which may be a wireless communications device. As discussed above, such wireless devices may be compatible with one or more wireless protocols, such as a Wi-Fi protocol or a Bluetooth protocol. In some embodiments, wireless device 102 includes collocated transceivers. For example, wireless device 102 may include a Wi-Fi transceiver and a Bluetooth transceiver that share access to a communications medium. More specifically, wireless device 102 may include a first transceiver, such as transceiver 104, and a second transceiver, such as transceiver 105. Transceiver 104 may be compatible with a Wi-Fi specification and protocol, and transceiver 105 may be compatible with a Bluetooth specification and protocol. In some embodiments, the Bluetooth protocol may be a Bluetooth Low Energy (BLE) protocol. In various embodiments, wireless device 102 may be a smart device, such as those found in wearable devices, or may be a monitoring device, such as those found in smart buildings, environmental monitoring, and energy management. It will be appreciated that such wireless devices may be any suitable device, such as those found in cars, other vehicles, and gaming systems.

As shown in FIG. 1, various wireless communications devices may be in communication with each other via one or more wireless communications mediums. Moreover, wireless device 102 may include one or more antennas, and may also include processing device 106. As disclosed herein a transceiver may also have associated transmit and receive chains and processing logic included in a corresponding radio. As will be discussed in greater detail below, such processing devices, transceivers, and radios may be configured to establish communications connections with other devices and transmit data in the form of data packets via such communications connections and in accordance with a wireless protocol. Accordingly, wireless devices, such as wireless device 102, are configured to generate and implement puncture patterns and hopping patterns to partition and share available bandwidth between collocated transceivers.

As will be discussed in greater detail below, a puncture pattern may refer to a data object that identifies one or more unused sub-channels of a transceiver. The data object may include a mapping that may provide an encoded representation of such unused sub-channels. Moreover, hopping patterns may refer to a sequence or order of sub-channels traversed by a transceiver during wireless communication operations. Accordingly, the hopping pattern may be a data object configured to identify active or used sub-channels of a transceiver, as well as a sequence of their respective use.

In some embodiments, system 100 may further include devices 108 which may also be wireless devices. As similarly discussed above, devices 108 may be compatible with one or more wireless transmission protocols, such as a Wi-Fi protocol or a Bluetooth protocol. In some embodiments, devices 108 may be configured as stations in communication with wireless device 102. For example, devices 108 may be smart devices or other devices, such as those found in gaming systems, cars, or other vehicles. In various embodiments, devices 108 may be different types of devices than wireless device 102. As discussed above, each of devices 108 may include one or more antennas, as well as processing devices and transceivers, which may also be configured to establish communications connections with other devices and transmit data in the form of data packets via such communications connections. As discussed above, devices 108 may also be configured to generate and implement puncture patterns and hopping patterns to partition and share available bandwidth between collocated transceivers.

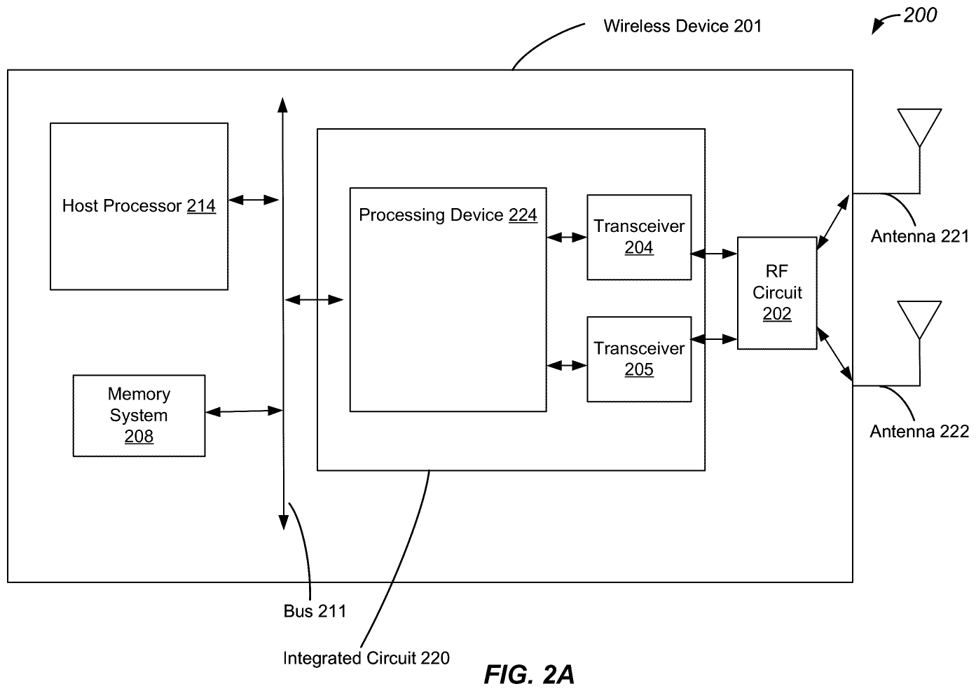

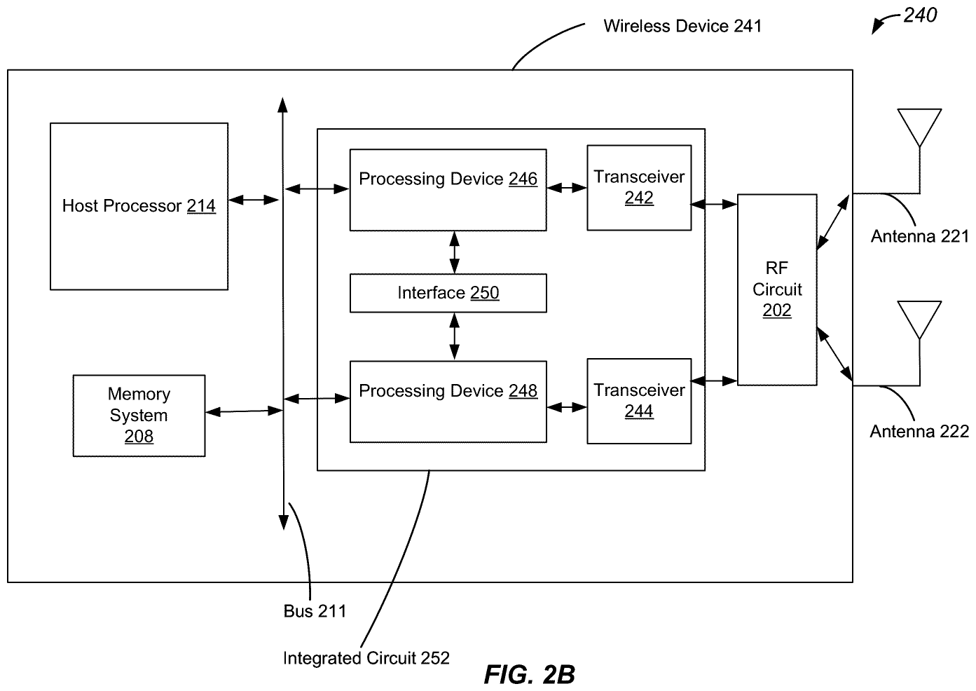

FIG. 2A illustrates an example of a device for coexistence enhancement, configured in accordance with some embodiments. More specifically, FIG. 2A illustrates an example of a system, such as system 200, that includes wireless device 201. It will be appreciated that wireless device 201 may be one of any of the wireless devices discussed above with reference to FIG. 1, such as wireless device 102 and devices 108.

In various embodiments, wireless device 201 includes one or more transceivers, such as transceiver 204 and transceiver 205. In one example, system 200 includes transceiver 204 which is configured to transmit and receive signals using a communications medium that may include antenna 221 or antenna 222. As noted above, transceiver 204 may be a Wi-Fi transceiver. Accordingly, transceiver 204 may be compatible with a Wi-Fi communications protocol, such as an 802.11be protocol. In various embodiments, transceiver 204 includes a modulator and demodulator as well as one or more buffers and filters, that are configured to generate and receive signals via antenna 221 and/or antenna 222.

System 200 additionally includes transceiver 205 which may be collocated with transceiver 204 in wireless device 201. In various embodiments, transceiver 205 is also be configured to transmit and receive signals using a communications medium that may include antenna 221 or antenna 222. Accordingly, transceiver 205 may be a Bluetooth transceiver compatible with a Bluetooth communications protocol. In one example, the Bluetooth protocol may be a BLE protocol. Moreover, transceiver 205 includes a modulator and demodulator as well as one or more buffers and filters, that are configured to generate and receive signals via antenna 221 and/or antenna 222. While various embodiments are described with reference to Bluetooth and Wi-Fi communications protocols, it will be appreciated that any suitable protocol may be used. For example, transceiver 205 may be an ultrawideband (UWB) transceiver, an IEEE 802.15.4 transceiver, or a narrowband internet-of-things transceiver.

In various embodiments, system 200 further includes processing device 224 which may include logic implemented using processing elements and/or one or more processor cores. Accordingly, processing device 224 includes one or more processing devices comprising processing elements that are configured to generate and implement puncture patterns and hopping patterns to partition and share available bandwidth between collocated transceivers. Moreover, processing device 224 includes one or more components configured to implement a medium access control (MAC) layer that is configured to control hardware associated with a wireless transmission medium, such as that associated with a Wi-Fi transmission medium. For example, processing device 224 may be configured to implement a driver, such as a Bluetooth and/or Wi-Fi driver, and may also be configured to include microcode.

In various embodiments, processing device 224 includes multiple processor cores which are each configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers.

System 200 further includes radio frequency (RF) circuit 202 which is coupled to antenna 221 and antenna 222. In various embodiments, RF circuit 202 may include various components such as an RF switch, a diplexer, and a filter. While FIG. 2A illustrates system 200 as having two antennas, it will be appreciated that system 200 may have a single antenna, or any suitable number of antennas. Accordingly, RF circuit 202 may be configured to select an antenna for transmission/reception and may be configured to provide coupling between the selected antenna, such as antenna 221, and other components of system 200 via a bus, such as bus 211. While one RF circuit is shown, it will be appreciated that wireless device 201 may include multiple RF circuits. Accordingly, each of multiple antennas may have its own RF circuit. Moreover, each one may be associated with a particular wireless communications protocol, such as a first antenna and RF circuit for Wi-Fi and a second antenna and RF circuit for Bluetooth.

System 200 includes memory system 208 which is configured to store one or more data values associated with puncture pattern and hopping pattern operations discussed above and in greater detail below. Accordingly, memory system 208 includes storage device, which may be a non-volatile random access memory (NVRAM) configured to store such data values and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204, transceiver 205, and processing device 224 may be implemented on the same integrated circuit chip, such as integrated circuit chip 220. In another example, transceiver 204, transceiver 205, and processing device 224 may each be implemented on their own chip, and thus may be disposed separately as a multi-chip module or on a common substrate such as a printed circuit board (PCB). It will also be appreciated that components of system 200 may be implemented in the context of a gaming system, a low energy device, a smart device, or a vehicle such as an automobile. Accordingly, some components, such as integrated chip 220, may be implemented in a first location, while other components, such as antenna 221, may be implemented in second location, and coupling between the two may be implemented via a coupler such as RF circuit 202, or leakage over the air or via the circuit board.

FIG. 2B illustrates another example of a device for coexistence enhancement, configured in accordance with some embodiments. As similarly discussed above, FIG. 2B illustrates an example of a system, such as system 240, that includes wireless device 241. Moreover, wireless device 241 may include host processor 214, memory system 208, bus 211, antenna 221, antenna 222, RF circuit 202. It will be appreciated that wireless device 241 may be one of any of the wireless devices discussed above with reference to FIG. 1, such as wireless device 102 and devices 108.

In various embodiments, wireless device 241 further includes integrated circuit 252 which is configured to implement collocated transceivers such as transceiver 242 and transceiver 244. As discussed above, the collocated transceivers may be configured to be compatible with different communications protocols. For example, transceiver 242 may be configured as a Wi-Fi transceiver and transceiver 244 may be configured as a Bluetooth transceiver. As shown in FIG. 2B, each of transceiver 242 and transceiver 244 may have dedicated processing devices such as processing device 246 and processing device 248 which may be configured to implement various layers underlying the communications protocols.

Moreover, integrated circuit 252 may include interface 250 which may be implemented between processing device 246 and processing device 248, and may be configured to facilitate communication between the processing devices to enable bandwidth partitioning and sharing disclosed herein. For example, processing device 246 may generate a puncture pattern and may pass the puncture pattern to processing device 248 via interface 250. Processing device 248 may then receive the puncture pattern and use it to generate a hopping pattern that may include sub-channels identified in the puncture pattern. Accordingly, interface 250 may be configured to data objects between processing devices as will be discussed in greater detail below.

In one example, interface 250 may include a local transmission control protocol (TCP) server configured to provide a communications interface for transceiver 242. Moreover, interface 250 may further include a local TCP client configured to provide a communications interface for transceiver 244. In this way, interface 250 may include TCP servers and clients configured to manage data object transfers between transceivers. In another example, interface 250 may be configured as a serial enhanced coexistence interface (SECI).

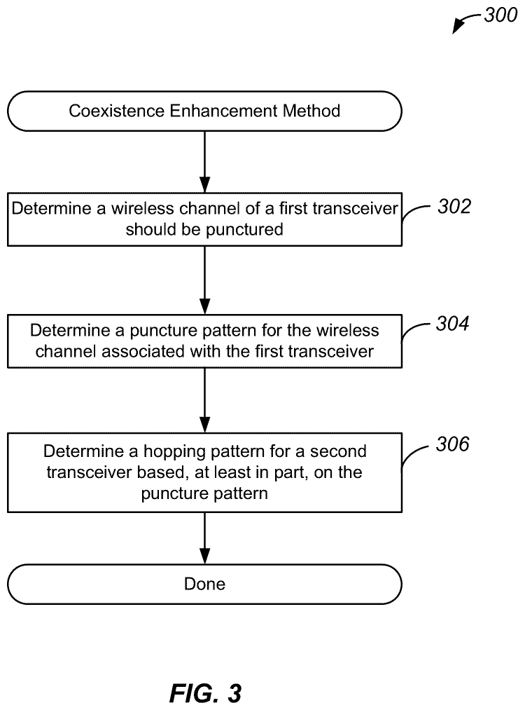

FIG. 3 illustrates an example of a method for coexistence enhancement, performed in accordance with some embodiments. As similarly discussed above, transceivers may be collocated within a wireless device, and may coordinate their operation to reduce channel interference. As will be discussed in greater detail below, a first transceiver may be configured to identify sub-channels that are not being used and/or have been identified to not be used, and may be further configured to enable a second transceiver to use those identified subchannels. In this way, sub-channels not used by a first transceiver may be allocated to a second transceiver to more efficiently use the bandwidth of the first transceiver.

Method 300 may perform operation 302 during which it may be determined that a wireless channel of a first transceiver should be punctured. In various embodiments, such a determination may be made based on a determination that one or more sub-channels are not going to be used by a first transceiver. For example, processing logic of the first transceiver may be configured to determine that one or more sub-channels will not be used in an upcoming transmission period, and such a determination may be made based on network schedule information generated by the first transceiver.

Method 300 may perform operation 304 during which a puncture pattern may be determined for the wireless channel associated with the first transceiver. Accordingly, the first transceiver may generate a data structure that includes one or more data values identifying the punctured sub-channels. As will be discussed in greater detail below, the puncture pattern may be encoded in the data structure as a bit map. In various embodiments, the first transceiver may also communicate the puncture pattern to a second transceiver that is collocated with the first transceiver.

Method 300 may perform operation 306 during which a hopping pattern may be determined for a second transceiver based, at least in part, on the puncture pattern. Accordingly, the second transceiver may generate a hopping pattern that identifies a sequence of channels that will be used by the second transceiver for upcoming communications. In various embodiments, the hopping pattern is configured to include the sub-channels identified in the puncture pattern. In this way, channel hopping of the second transceiver may be configured to include unused sub-channels of the first transceiver, and in a manner that may be implemented dynamically such that the puncture pattern and hopping pattern may be dynamically updated based on upcoming wireless activity.

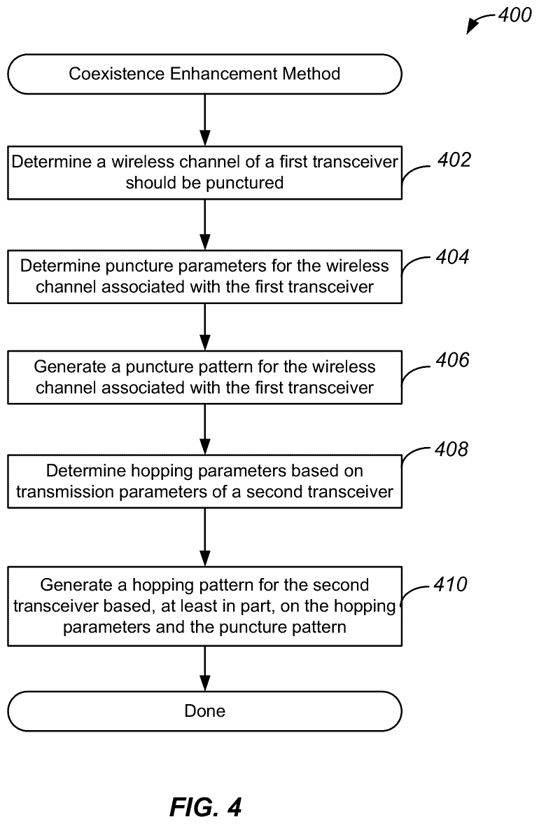

FIG. 4 illustrates another example of a method for coexistence enhancement, performed in accordance with some embodiments. As similarly discussed above, a first transceiver may be configured to identify sub-channels that are not being used, and may be further configured to enable a second transceiver to use those identified subchannels. As will be discussed in greater detail below, a puncture pattern may be communicated from the first transceiver to the second transceiver, and the second transceiver may use the puncture pattern to implement its own channel hopping.

Method 400 may perform operation 402 during which it may be determined that a wireless channel of a first transceiver should be punctured. As similarly discussed above, such a determination may be made based on a determination that one or more sub-channels are not going to be used by a first transceiver. For example, processing logic of the first transceiver may be configured to determine that one or more sub-channels will not be used in an upcoming transmission period, and such a determination may trigger the generation of a puncture pattern.

Method 400 may perform operation 404 during which puncture parameters may be determined for the wireless channel associated with the first transceiver. In various embodiments, the puncture parameters may define features of the puncturing to be applied to the frequency band of the first transceiver. For example, puncture parameters may identify the sub-channels to be punctured as well as frequency ranges associated with those sub-channels. In some embodiments, the puncture parameters may be determined based on upcoming wireless traffic information, such as network schedule information generated by the first transceiver that identifies which sub-channels will be used for which transmit and/or receive operations.

Method 400 may perform operation 406 during which a puncture pattern may be generated for the wireless channel associated with the first transceiver. In various embodiments, the puncture pattern may be generated based on the puncture parameters. Accordingly, the puncture pattern may provide a comprehensive representation of all sub-channels and their associated frequency bands that will not be used by the first transceiver and that may be used by a second transceiver for a designated duration of time. As discussed above, the puncture pattern may be included in a data structure using an encoding scheme. As will be discussed in greater detail below, the encoding scheme may a bitmap data structure that both the first transceiver and the second transceiver are configured to interpret and decode.

Method 400 may perform operation 408 during which hopping parameters may be determined based on transmission parameters of a second transceiver. In various embodiments, the hopping pattern may be determined by the second transceiver and may be generated in accordance with a specification and protocol of the second transceiver. For example, the second transceiver may be a Bluetooth transceiver, and may generate a hopping pattern based on parameters specified by the Bluetooth standard. Accordingly, such hopping parameters may specify when a hop should be implemented, and in what order. In various embodiments, the hopping parameters may be determined based on additional information, such as a medium access control (MAC) address.

Method 400 may perform operation 410 during which a hopping pattern may be generated for the second transceiver based, at least in part, on the hopping parameters and the puncture pattern. In various embodiments, the hopping pattern may be a data object that identifies upcoming transmit and/or receive activity of the second transceiver, and also maps identified hops to the transmit/receive operation. In some embodiments, sub-channels included in a hopping pattern may be identified based on one or more metrics, such as an average signal to noise ratio (SNR) and/or packet error rate. The sequence of the sub-channels within the hopping pattern may be randomized.

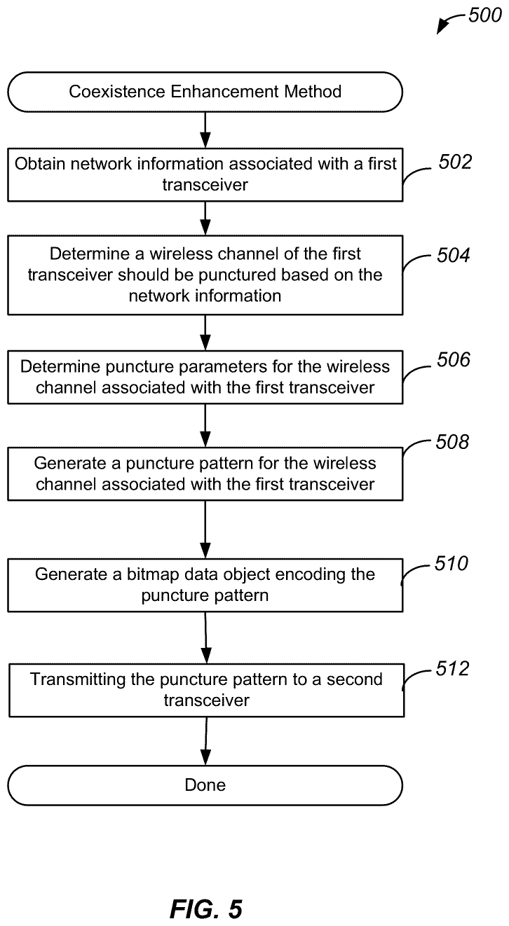

FIG. 5 illustrates an additional example of a method for coexistence enhancement, performed in accordance with some embodiments. As similarly discussed above, a first transceiver may be configured to identify sub-channels that are not being used, and may be further configured to enable a second transceiver to use those identified subchannels. As will be discussed in greater detail below, a puncture pattern may be generated and encoded in a data structure configured to convey such information from the first transceiver to the second transceiver.

Method 500 may perform operation 502 during which network information associated with a first transceiver may be obtained. In various embodiments, such network information may include a schedule of upcoming network traffic for the first transceiver. Accordingly, such network information may identify upcoming transmit and receive operations to be performed by the first transceiver, as well as expected portions of a communications channel to be used by the first transceiver for such transmit and receive operations. As similarly discussed above, such portions of the communications channel may be represented as sub-channels within a wireless channel. Moreover, transmit and receive activity may be obtained from a component of the first transceiver and associated processing logic, such as a traffic arbiter and/or scheduler.

In some embodiments, such network information may include observed behavior over a wireless network. Accordingly, the first transceiver may observe over-the-air activity and associated data packet activity, and may identify active sub-channels based on such observed activity. In some embodiments, a request for puncturing may be received from a downstream device, such as a station. Accordingly, a station may send an access point a data packet including a request for a puncture pattern, and the data packet may be received by the access point.

Method 500 may perform operation 504 during which it may be determined that a wireless channel of the first transceiver should be punctured based on the network information. In various embodiments, such a determination may be made based on the received network information. For example, based on the upcoming transmit and receive activity, it may be determined that one or more sub-channels are not going to be used by the first transceiver. As similarly discussed above, such a determination may trigger the generation of a puncture pattern.

Method 500 may perform operation 506 during which puncture parameters may be determined for the wireless channel associated with the first transceiver. In various embodiments, the puncture parameters may define features of the puncturing to be applied to the frequency band of the first transceiver. For example, puncture parameters may identify the sub-channels to be punctured as well as frequency ranges associated with those sub-channels. Accordingly, the puncture parameters may be determined based on the received network information and associated puncture parameters.

Method 500 may perform operation 508 during which a puncture pattern may be generated for the wireless channel associated with the first transceiver. As similarly discussed above, the puncture pattern may be generated based on the puncture parameters. Accordingly, the puncture pattern may identify all sub-channels, and their associated frequency bands, that will not be used by the first transceiver and that may be used by a second transceiver.

Method 500 may perform operation 510 during which a bitmap data object may be generated. In various embodiments, the bitmap data object is configured to include data values that encode the generated puncture pattern. In various embodiments, the puncture pattern is included in a portion of a data packet. For example, the encoded puncture pattern may be included as a disable sub-channel bitmap in operation parameters of a preamble of a data packet, such as a beacon frame. It will be appreciated that the puncture pattern may be included in other data packets as well, such as a probe response. In various embodiments, the encoding scheme may identify sub-channels of a channel, and may also include one or more data values, such as flags, that may be set to identify a puncturing status. For example, if a flag is set to “X”, a sub-channel may be punctured. Additional details are discussed in greater detail below with reference to Table 1.

TABLE 1

| Bandwidth | Puncture Status | Puncture Pattern | Identifier |
|---|---|---|---|
| 320 MHz | No puncturing | [1 1 1 1 1 1 1 1] | 0 |
| | 40 MHz Puncturing | [X 1 1 1 1 1 1 1] | 1 |
| | | [1 X 1 1 1 1 1 1] | 2 |
| | | [1 1 X 1 1 1 1 1] | 3 |
| | | [1 1 1 X 1 1 1 1] | 4 |
| | | [1 1 1 1 X 1 1 1] | 5 |
| | | [1 1 1 1 1 X 1 1] | 6 |
| | | [1 1 1 1 1 1 X 1] | 7 |
| | | [1 1 1 1 1 1 1 X] | 8 |
| | 80 MHz Puncturing | [X X 1 1 1 1 1 1] | 9 |
| | | [1 1 X X 1 1 1 1] | 10 |
| | | [1 1 1 1 X X 1 1] | 11 |
| | | [1 1 1 1 1 1 X X] | 12 |

As shown in Table 1 available bandwidth of a transceiver may be punctured at various levels of granularity. For example, puncturing may be determined in 40 MHz increments, or in 80 MHz increments. A sequence of data values may be configured as flags that may be set to define a puncture pattern. As shown in Table 1, flags set as “X” are configured to identify a sub-channel or grouping of sub-channels as punctured, and flags set as “1” are configured to identify a sub-channel or grouping of sub-channels as not punctured and in use. In some embodiments, an identifier may also be used as a shorthand representation of the puncture pattern and status.

Method 500 may perform operation 512 during which the puncture pattern is transmitted to a second transceiver. In one example, the puncture pattern may be sent from the first transceiver to the second transceiver via an interface or other communications bus. As will be discussed in greater detail below, the second transceiver may use the puncture pattern to generate a hopping pattern for its own upcoming network activity. In some embodiments, the puncture pattern may be included in a preamble of a data packet that is transmitted. For example, a station may communicate the puncture pattern to an access point that may then process the puncture pattern.

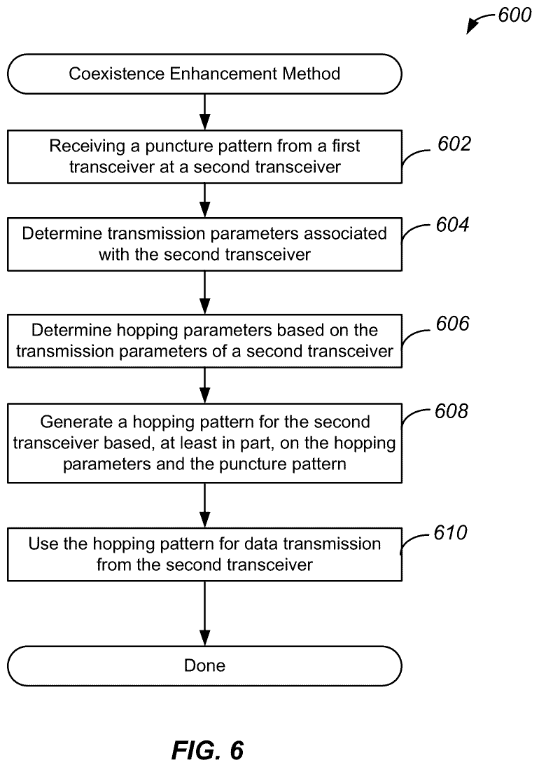

FIG. 6 illustrates another example of a method for coexistence enhancement, performed in accordance with some embodiments. As similarly discussed above, a first transceiver may be configured to identify sub-channels that are not being used, and may be further configured to enable a second transceiver to use those identified subchannels. As will be discussed in greater detail below, a puncture pattern may be used to generate a hopping pattern which may be used by the second transceiver for transmit and receive operations.

Method 600 may perform operation 602 during which a puncture pattern may be received from a first transceiver at a second transceiver. Accordingly, as discussed above, the puncture pattern may have been included in a data object that is transmitted from the first transceiver to the second transceiver via a communications interface or other communications bus.

Method 600 may perform operation 604 during which transmission parameters associated with the second transceiver may be determined. In various embodiments, the transmission parameters may be determined based on available network activity of the second transceiver. As similarly discussed above, such network activity may be determined based on schedule and traffic information available from one or more components associated with the second transceiver, such as a traffic arbiter and/or scheduler. Accordingly, transmission parameters identifying upcoming transmit activity may be determined.

Method 600 may perform operation 606 during which hopping parameters may be determined based on the transmission parameters of a second transceiver. As similarly discussed above, the hopping pattern may be determined by the second transceiver and may be generated in accordance with a specification and protocol of the second transceiver. For example, the second transceiver may be a Bluetooth transceiver, and may generate a hopping pattern based on parameters specified by the Bluetooth standard. Accordingly, such hopping parameters may specify when a hop should be implemented, and in what order of sub-channels. In various embodiments, the hopping parameters may be determined based on additional information, such as a medium access control (MAC) address.

In various embodiments, the hopping pattern is configured to include one or more punctured sub-channels as identified by the received puncture pattern. Accordingly, the hopping parameters may be updated to include the identified punctured sub-channels of the first transceiver. In this way, the hopping parameters of the second transceiver may be augmented to include additional sub-channels of the first transceiver.

Method 600 may perform operation 608 during which a hopping pattern may be generated for the second transceiver based, at least in part, on the hopping parameters and the puncture pattern. As similarly discussed above, the hopping pattern may be a data object that identifies upcoming transmit and/or receive activity of the second transceiver, and also maps identified hops to transmit/receive operations. Moreover, sub-channels included in the hopping pattern may be identified based on signal quality metrics, and a sequence of the hopping pattern may be randomized.

Method 600 may perform operation 610 during which the hopping pattern may be used for data transmission from the second transceiver. Accordingly, the second transceiver may implement the transmission operations, and may use the hopping pattern to implement hopping across various sub-channels. In various embodiments, the sub-channels may include punctured sub-channels of the first transceiver as identified in the puncture pattern received during operation 602. Accordingly, the hopping pattern may include sub-channels within the designated bandwidth of the first transceiver, and the hopping of the second transceiver may be bounded within the punctured sub-channels that are unused by the first transceiver.

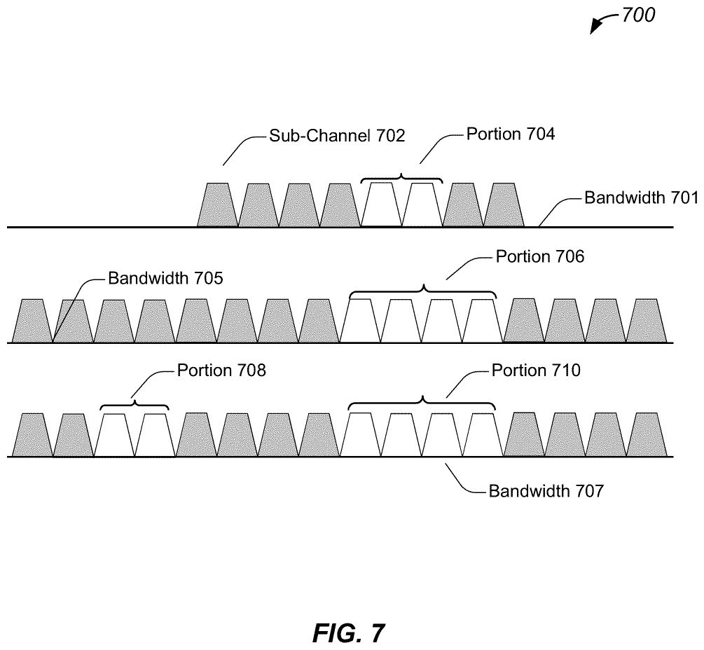

FIG. 7 illustrates an example of a diagram of various sub-channels and puncture features, configured in accordance with some embodiments. As shown in image 700, an available bandwidth of a transceiver, such as bandwidth 701, may be partitioned into multiple sub-channels, such as sub-channel 702. In various embodiments, a sub-channel may represent a designated portion of a frequency range of the frequency band of the transceiver. For example, each of the sub-channels may be a 20 MHz partition of the total frequency band. As discussed above, a portion, such as portion 704, of sub-channels may be identified as punctured sub-channels that are not used by the transceiver. As shown in FIG. 7, portion 704 includes two sub-channels.

In another example, a portion, such as portion 706, of sub-channels may be identified as punctured sub-channels of bandwidth 705. As shown in FIG. 7, portion 706 includes four sub-channels collectively having a size of 80 MHz if each sub-channel is 20 MHz. Accordingly, a size of a punctured portion may be configurable and specified in the encoded puncture pattern. Thus, according to some embodiments, the puncture pattern is configured to identify punctured sub-channels with a granularity that is variable and configurable. In some embodiments, a lower granularity and larger portion size may use fewer data values in an encoded puncture pattern, and thus result in a smaller data object.

In an additional example, bandwidth 707 may include multiple identified punctured portions, such as portion 708 and portion 710. As shown in FIG. 7, portion 708 and portion 710 have different sizes, as shown by their different number of contiguous sub-channels. Moreover, portion 708 and portion 710 are noncontiguous with each other and are divided by used sub-channels. Accordingly, a puncture pattern may identify punctured portions that have different levels of granularity and are of different sizes, and that are also noncontiguous within the bandwidth of the transceiver. It will be appreciated that each portion may be identified by a flag in an encoded puncture pattern, as discussed above. In this way, the encoded puncture pattern can configurably represent multiple punctured groups of sub-channels despite variations in size and a lack of contiguity.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
identifying, using one or more processing elements, wireless activity associated with a first transceiver, the first transceiver being collocated with a second transceiver;
generating, using the one or more processing elements, a puncture pattern for the first transceiver based, at least in part, on the identified wireless activity, the puncture pattern identifying an unused plurality of sub-channels of the first transceiver; and
generating, using the one or more processing elements, a hopping pattern for the second transceiver based, at least in part, on the puncture pattern, the hopping pattern identifying a sequence of sub-channels used by the second transceiver for wireless activity, and the hopping pattern including at least some of the plurality of sub-channels identified by the puncture pattern.

2. The method of claim 1, wherein the first transceiver is a Wi-Fi transceiver, and wherein the second transceiver is a Bluetooth transceiver, an 802.15.4 transceiver, or a narrowband internet-of-things transceiver.

3. The method of claim 1, wherein the generating of the puncture pattern comprises:
generating a bitmap data structure identifying the unused plurality of sub-channels

4. The method of claim 3 further comprising:
transmitting the bitmap data structure from the first transceiver to the second transceiver.

5. The method of claim 3, wherein the bitmap data structure is encoded.

6. The method of claim 3, wherein the bitmap data structure is included in a data packet.

7. The method of claim 1, wherein the unused plurality of sub-channels is noncontiguous.

8. The method of claim 1, wherein the unused plurality of sub-channels comprises a plurality of portions of contiguous sub-channels.

9. The method of claim 8, wherein the plurality of portions of contiguous sub-channels has different sizes.

10. A system comprising:
a first transceiver compatible with a first wireless communications protocol;
a second transceiver compatible with a first wireless communications protocol, the first transceiver and the second transceiver being collocated; and
a processing device comprising processing elements configured to:
identify wireless activity associated with the first transceiver;
generate a puncture pattern for the first transceiver based, at least in part, on the identified wireless activity, the puncture pattern identifying an unused plurality of sub-channels of the first transceiver; and
generate a hopping pattern for the second transceiver based, at least in part, on the puncture pattern, the hopping pattern identifying a sequence of sub-channels used by the second transceiver for wireless activity, and the hopping pattern including at least some of the plurality of sub-channels identified by the puncture pattern.

11. The system of claim 10, wherein the processing device is further configured to:
generate a bitmap data structure identifying the unused plurality of sub-channels.

12. The system of claim 11, wherein the processing device is further configured to:
transmit the bitmap data structure from the first transceiver to the second transceiver.

13. The system of claim 11, wherein the bitmap data structure is encoded.

14. The system of claim 10, wherein the unused plurality of sub-channels is noncontiguous.

15. The system of claim 10, wherein the unused plurality of sub-channels comprises a plurality of portions of contiguous sub-channels having different sizes.

16. A device comprising:
processing elements configured to:
identify wireless activity associated with a first transceiver;
generate a puncture pattern for the first transceiver based, at least in part, on the identified wireless activity, the puncture pattern identifying an unused plurality of sub-channels of the first transceiver; and
generate a hopping pattern for a second transceiver based, at least in part, on the puncture pattern, the hopping pattern identifying a sequence of sub-channels used by the second transceiver for wireless activity, and the hopping pattern including at least some of the plurality of sub-channels identified by the puncture pattern.

17. The device of claim 16, wherein the processing elements are further configured to:
generate a bitmap data structure identifying the unused plurality of sub-channels.

18. The device of claim 17, wherein the processing elements are further configured to:
transmit the bitmap data structure from the first transceiver to the second transceiver.

19. The device of claim 16, wherein the unused plurality of sub-channels is noncontiguous.

20. The device of claim 16, wherein the unused plurality of sub-channels comprises a plurality of portions of contiguous sub-channels having different sizes.
